(19) United States
(12) Patent Application Publication
(10) Pub. No.: US 2021/0148576 A1
(43) Pub. Date: May 20, 2021

(54) FASTENING SYSTEM FOR A HEATING ELEMENT OF A COOKING HOB

(71) Applicant: ELECTROLUX APPLIANCES AKTIEBOLAG, Stockholm (SE)

(72) Inventors: Claudio PAOLINI, Forli (IT); Laurent JEANNETEAU, Forli (IT); Filippo MILANESI, Forli (IT); Alex VIROLI, Forli (IT)

(21) Appl. No.: 16/626,694

(22) PCT Filed: Jul. 1, 2018
(86) PCT No.: PCT/EP2018/067723

§ 371 Date: Dec. 26, 2019

(30) Foreign Application Priority Data
Jul. 3, 2017 (EP) 17179401.9

(51) Int. Cl. F24C 7/06; F24C 15/10; H05B 6/12

(52) U.S. Cl. CPC F24C 7/067; H05B 2206/022; H05B 6/1245; F24C 15/104

(57) ABSTRACT

The present invention relates to a fastening system for a heating element (22) of a cooking hob, in particular for an induction coil (22) of an induction cooking hob. The fastening system comprises at least three fastening elements comprising a main body connectable or connected to a support structure, particularly to a bottom and/or side wall of the cooking hob. Further, the present invention relates to a heating element (22) for a cooking hob. Moreover, the present invention relates to a cooking hob.

The present invention relates to a fastening system for a heating element of a cooking hob. In particular, the present invention relates to a fastening system for an induction coil of an induction cooking hob. Further, the present invention relates to a heating element for a cooking hob. Moreover, the present invention relates to a cooking hob.

Usually, a heating element of a cooking hob has predetermined fixing points. FIG. 7 illustrates a schematic top view of the heating element 22 for the cooking hob with fastening elements 10 according to the prior art. The heating element 22 may be an induction coil 22 or a radiant heating element. The heating element 22 comprises three fastening elements 10. Said fastening elements 10 are arranged at predefined positions at the heating element 22. The positions of the fastening elements 10 at the heating element 22 cannot be varied. The heating element 22 with the fastening elements 10 cannot be adapted to special geometric conditions of the cooking hob. In that, the heating element 22 is designed for being used in a specific cooking hob, or a specific cooking hob platform, and there is no flexibility to use the heating element 22 for another cooking hob or another cooking hob platform with a design or structure which is even only slightly different from the specific one.

It is an object of the present invention to provide a fastening system for a heating element of a cooking hob, which allows a flexible arrangement of the heating element both on one and the same cooking hob and on different cooking hobs, in particular cooking hobs from different product platforms.

The object is achieved by the fastening system according to claim 1.

According to the present invention a fastening system for a heating element of a cooking hob, in particular for an induction coil of an induction cooking hob is provided, wherein the fastening system comprises at least three fastening elements comprising a main body connectable or connected to a support structure of the cooking hob, particularly to a bottom and/or side wall of the cooking hob.

At least one fastening element may comprise a moveable hook element and a fixed hook element which are contacting each other or are connected to each other or are marginally spaced from each other in an assembled state of the heating element.

In particular, at least one fastening element includes a snap-in mechanism connectable or connected to a fixation hole of the heating element, wherein preferably the snap-in mechanism includes a fixed hook element arranged directly on the main body and/or a moveable hook element connected to the main body via a flexible supporting arm. This embodiment may also comprise the solution of the moveable hook element and the fixed hook element being contacting each other or being connected to each other or being marginally spaced from each other in an unstressed state of the snap-in mechanism.

As an alternative solution, the snap-in mechanism may include two moveable hook elements, each one being connected to the main body via a dedicated flexible supporting arm. Also this alternative solution may provide for the situation that the two hook elements are contacting each other or are connected to each other or are marginally spaced from each other in an unstressed state of the snap-in mechanism.

One target for the present invention is to provide a fastening system enabling the fastening elements to be fixable in arbitrary positions along the circumference of the heating element. Thus, the shape of the heating element with the fastening elements may be variable and may be adaptable to the geometric conditions of the cooking hob.

Preferably, the fixed hook element is arranged directly on a top side of the main body.

In particular, the moveable hook element is connected to the top side of the main body via the flexible supporting arm.

The fastening element may be formed as a single-piece part. Additionally or alternatively, the fastening element may be made of plastics.

The fastening elements may be connectable or connected to the support structure, in particular with their main body, by means of gluing, screwing, snapping, frictionally engaged fastening or any other connecting means. Alternatively, the fastening elements may be already part of the support structure, in particular in a one-piece solution, e. g. the fastening means are moulded in case of not only the fastening element but also the support structure being made of plastics.

In a preferred embodiment of the fastening system, at least one fastening element comprises a hook element and/or a screw which is or which are moveable into or towards the main body of the fastening element. Another alternative solution to the hook element or the screw, respectively, may be a fitting element, or the like, being attached to the main body and having a spring function in order to resiliently enable the assembly of the heating element and, at the end of the assembling process, to move towards or into the main body.

The main body may be formed as a pillar.

Preferably, a screw is insertable or screwable into said main body or pillar, respectively. The screw is an alternative to the snap-in mechanism including the fixed hook element and/or the moveable hook element. In that, the main body or the pillar, respectively, may be a socket with a hole or bore at its top or assembling side, working as a reception for the screw.

According to a specific embodiment, the moveable hook and/or the screw is or are supported by a supporting arm which is connected to or arranged at the main body of the fastening element, in particular at a top side of the main body.

The fastening system may comprise one, or at least one, heating element which is at least partially enclosed by a border with a plurality of fixing holes, wherein said fixing hole is penetrated or penetrable by the screw and/or engageable or engaged with the snap-in mechanism of the fastening element.

In particular, the fixed hook element and/or the moveable hook element penetrate the fixing hole, when said fixing hole is engaged with the snap-in mechanism of the fastening element.

Preferably, at least one fastening element of the fastening system includes at least one electric connector connectable or connected to a complementary electric connector of the heating element. In a preferred embodiment, the fastening element comprising the electric connector is of the same shape as the fastening element without such connector in order to enable a flexible arrangement within the cooking hob.

For example, at least one fastening element of the fastening system includes at least one socket connectable or connected to a plug of the heating element. Additionally or alternatively, the at least one socket may be connected or wired with a power cable and/or a signal or sensor cable, the cable or cables being connected or connectable to an electric or electronic component or module of the cooking hob. Such electric or electronic component or module may be a power board or a user interface or a controller of the cooking hob.

The plug of the heating element may be connected to windings of the induction coil or a heating wire via power cables and/or to a sensor of the heating element via sensor cables.

Further, the present invention relates to a heating element for a cooking hob, in particular an induction coil of an induction cooking hob, wherein the heating element is at least partially enclosed by a border with a plurality of fixing holes, wherein each fixing hole is penetrated or penetrable by the screw and/or engageable or engaged with the fastening system, in particular the screw or the snap-in mechanism of the fastening system, mentioned above.

In particular, the fixing hole is penetrable by the fixed hook element and/or the moveable hook element, when said fixing hole is engaged with the fastening system, e. g. with the snap-in mechanism of the fastening system.

Preferably, the fixing holes are arranged along a circular path in the border of the heating element.

Further, at least one of the fixing holes is formed as a poka yoke element, wherein preferably said poka yoke element is a recess opened to an outer edge of the border and/or said poka yoke element is a slot or a key hole. Preferably, two or three of the fixing holes are formed as poka yoke elements. The poka yoke elements guarantee the correct installation of the heating element at the fastening elements. In an embodiment, not only the fixing hole but also the dedicated fastening element is formed as a poka yoke element. With such pair of aligned poka yoke elements, an even improved correct installation is guaranteed.

The poka yoke element may also work as positioning indicator, when the specific type of heating element is used in different hob solutions or platforms. With the help of this assembling aid, an assembly line worker is enabled to fit the heating element into the cooking hob in correct position.

Moreover, the heating element may include at least one electric connector connectable or connected to a complementary electric connector of the fastening system.

For example, the heating element includes at least one plug connectable or connected to at least one socket of the fastening system.

The plug of the heating element may be connected to windings of the induction coil or a heating wire via power cables and/or to a sensor of the heating element via sensor cables.

At last, the present invention relates to a cooking hob comprising at least one heating element, wherein the cooking hob comprises at least one fastening system and/or at least one heating element mentioned above.

The assembling of the heating element in the cooking hob may be performed by initially fixing the fastening elements in their dedicated fixation hole and, thereafter, connecting the fastening elements, in particular with their main bodies, to the support structure of the cooking hob. In a preferred embodiment, however, the assembling starts with a connection of the fastening elements at the support structure of the cooking hob, followed by an assembling of the heating element into the fastening system. Naturally, in case of the fastening elements being already in place within the cooking hob or its support structure, in particular if moulded with the support structure, the heating element can be directly fastened on the fastening system.

Novel and inventive features of the present invention are set forth in the appended claims.

The present invention will be described in further detail with reference to the drawings, in which

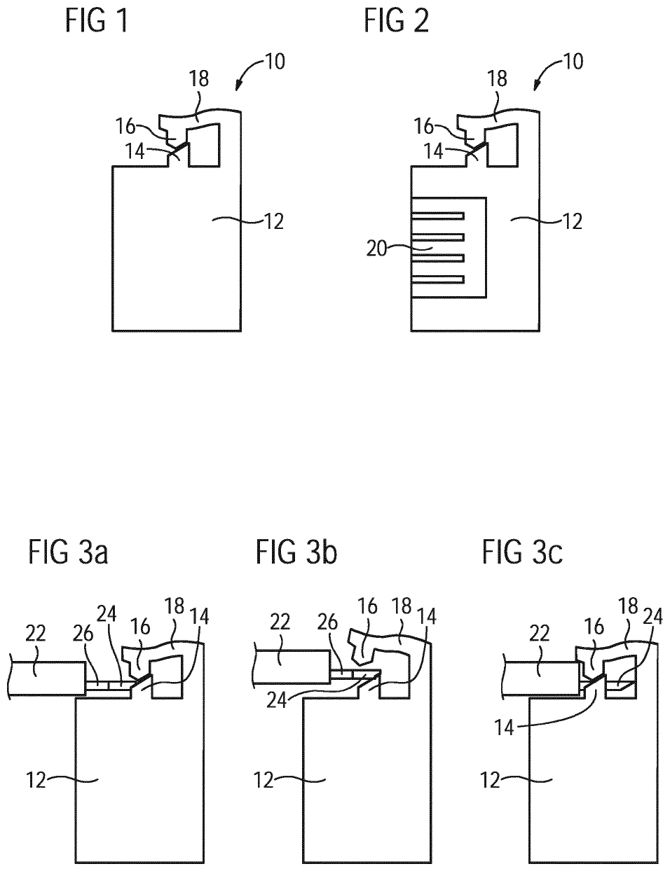

FIG. 1 illustrates a schematic sectional side view of a fastening element of a fastening system according to a preferred embodiment of the present invention,

FIG. 2 illustrates a schematic sectional side view of the fastening element with an electric connector according to the preferred embodiment of the present invention,

FIG. 3 illustrates three sectional side views of the fastening element during connecting said fastening element to a heating element according to the preferred embodiment of the present invention,

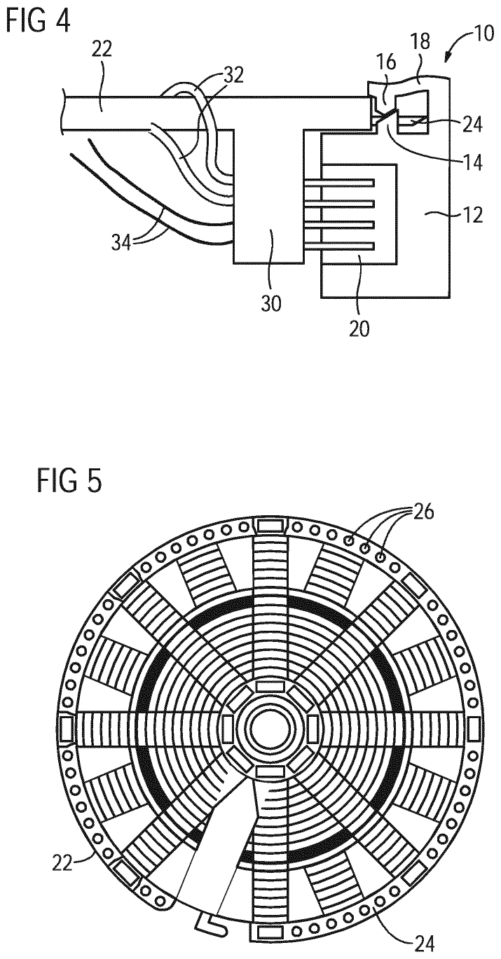

FIG. 4 illustrates a schematic sectional side view of the fastening element with the electric connector in an electric connection to the heating element to the preferred embodiment of the present invention,

FIG. 5 illustrates a schematic top view of the heating element according to the preferred embodiment of the present invention,

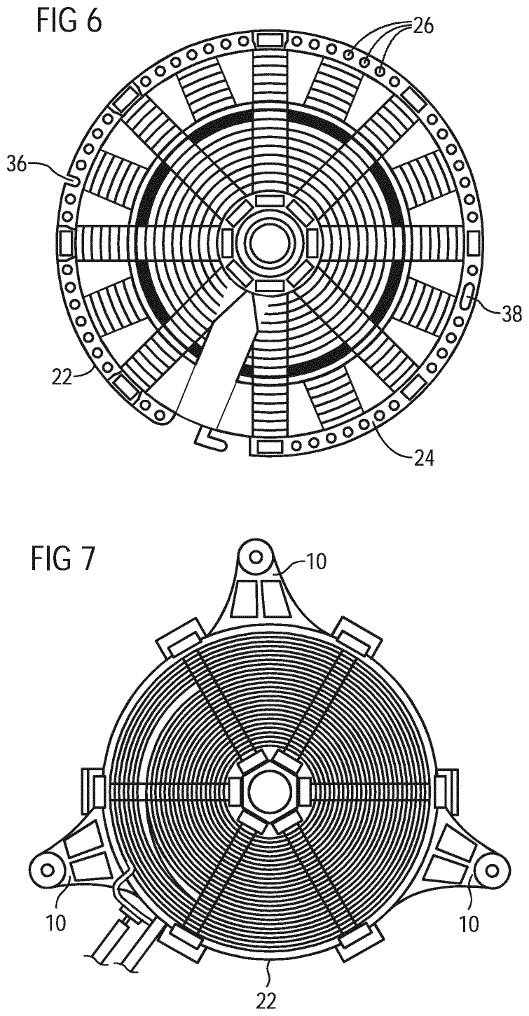

FIG. 6 illustrates a schematic top view of the heating element according to a further embodiment of the present invention, and

FIG. 7 illustrates a schematic top view of the heating element with fastening elements according to the prior art.

FIG. 1 illustrates a schematic sectional side view of a fastening element 10 of a fastening system according to a preferred embodiment of the present invention. The fastening system is provided for fastening a heating element 22 on a cooking hob. For example, the heating element 22 is an induction coil or a radiant heating element.

The fastening element 10 comprises a pillar 12 and a snap-in mechanism. In this example, the snap-in mechanism is arranged above the pillar 12. The snap-in mechanism includes a fixed hook element 14 and a moveable hook element 16. The fixed hook element 14 is arranged directly on the pillar 12, while the moveable hook element 16 is connected to the pillar 12 via a flexible supporting arm 18. In an unstressed state, the moveable hook element 16 is arranged upon the fixed hook element 14. In this example, the moveable hook element 16 and the fixed hook element 14 are marginally spaced from each other in said unstressed state. Preferably, the fastening element 10 is made of plastics and formed as a single-piece part.

The snap-in mechanism of the fastening element 10 is provided for receiving a border 24 of the heating element. The fastening element 10 is fixed on a bottom or at a side wall of the cooking hob. The fastening system comprises at least three fastening elements 10, wherein said fastening elements 10 are distributed around the heating element 22.

FIG. 2 illustrates a schematic sectional side view of the fastening element 10 with an electric connector 20 according to the preferred embodiment of the present invention.

In this example, the electric connector is a socket 20 provided for receiving a plug 30 of the heating element 22. Alternatively, the electric connector 20 may be a plug provided for receiving a socket of the heating element 22. The socket 20 is arranged in the pillar 12 of the fastening element 10.

At least one of the fastening elements 10 of the fastening system includes the socket 20 or electric connector 20, respectively. Thus, the fastening system provides a mechanical and electric connection between the heating element 10 and the cooking hob.

FIG. 3 illustrates three sectional side views of the fastening element 10 during connecting said fastening element 10 to the heating element 22 according to the preferred embodiment of the present invention.

FIG. 3a shows a situation, in which the fastening element 10 and the heating element 22 are not yet connected to each other. The border 24 of the heating element 22 encloses partially or completely said heating element 22. A plurality of fixation holes 26 is formed in the border 24 of the heating element 22. One of the said fixation holes 26 is provided for receiving the fixed hook element 14 and/or the moveable hook element 16 of the snap-in mechanism.

FIG. 3b shows a situation, in which the border 24 of the heating element 22 is pushed into the snap-in mechanism of the fastening element 10. Thereby the border 24 pushes upwards the moveable hook element 16, wherein the flexible supporting arm 18 is in a stressed state. The direction of assembling is perpendicular or radially to a centre axis of the fastening element 10, i. e. to the centre axis of the pillar 12.

As can be also seen in FIG. 3b, for an eased assembling, the fixed hook element 14 comprises an inclined insertion surface which is the top surface of the fixed hook element 14. Also the border 24 of the heating element 22 comprises at its outer edge an inclined insertion surface which is symmetrically and opposite the inclined insertion surface of the fixed hook element 14. Finally, the moveable hook element 16 comprises an inclined insertion surface, too, which is mirror-symmetrical to the inclined insertion surface of the fixed hook element 14 at the insertion side of the hook elements 14, 16. The pair of inclined insertion surfaces at the fixed hook element 14 and the moveable hook element 16 provide for a triangular (in its cross-section) insertion section which enables a particularly easy assembling.

FIG. 3c shows a situation, in which the fastening element 10 and the heating element 22 are connected to each other. The fixed hook element 14 and/or the moveable hook element 16 of the snap-in mechanism penetrate one of the fixing holes 26 in the border 24 of the heating element 22. The flexible supporting arm 18 is in the unstressed state. This is also the state of a finalized assembling and fastening of the heating element 22 in the snap-in mechanism. In this state, the heating element is resting on the top side of the pillar 12, so that the pillar 12 works as a support for the heating element 22.

The connection between the fastening element 10 and the heating element 22 can be made without any tools. Further, the fastening element 10 can be disconnected from the heating element 22 by pulling upwards the moveable hook element 16 and the flexible supporting arm 18, wherein no tool is required.

In order to provide an easy assembling operation when considering a fixation of the heating element 22 with three or more fastening elements 10 which are widely spaced from each other, the fastening elements 10 may be mounted or designed with some flexibility in radial direction. Additionally or alternatively, the fixation holes 26 may comprise respective clearances.

FIG. 4 illustrates a schematic sectional side view of the fastening element 10 with the electric connector 20 in an electric connection to the heating element 22 according to the preferred embodiment of the present invention.

The heating element 22 includes the plug 30, at least two power cables 32 and at least two sensor cables 34. The plug 30 is connected to the socket 20 of the fastening element 10. The power cables 32 are interconnected between the plug 30 and the windings of the induction coil or heating wire. The sensor cables 34 are interconnected between the plug 30 and a sensor of the heating element 22.

FIG. 5 illustrates a schematic top view of the heating element 22 according to the preferred embodiment of the present invention.

In this example, the heating element 22 is an induction coil 22. Alternatively, the heating element 22 may be a radiant heating element.

The heating element 22 is enclosed by the border 24. The plurality of fixing holes 26 is formed in the border 24 of the heating element 22. In this example, the border 24 comprises seven groups of fixing holes 26, wherein in turn each group includes seven fixing holes 26. Preferably, the fixing holes 26 are arranged along a circular path. The plurality of fixing holes 26 allows a flexible arrangement of three or more fastening elements 10 at the heating element 22. The same heating element 22 can be used in different applications. The positions of the three or more fastening elements 10 at the heating element 22 can be adapted to the geometric conditions of the cooking hob.

FIG. 6 illustrates a schematic top view of the heating element 22 according to a further embodiment of the present invention. The heating element 22 of FIG. 6 is similar as the heating element 22 shown in FIG. 5.

Additionally, some of the fixing holes 26 are formed as poka yoke elements 36. The poka yoke elements 36 guarantee the correct installation of the heating element 22 at the fastening elements 10. One poka yoke element is formed as a recess 36 opened to an outer edge of the border 24. Other poka yoke elements form a slot 38. Further, the poka yoke element may be formed as a key hole.

Alternatively, the fixation holes 26 are penetrated by screws, wherein said screws are inserted in the pillar 12 of the fastening element 10. In this case, the fastening element 10 does not require the snap-in mechanism with the fixed hook element 14 and the moveable hook element 16. The assembly operation, in this case, is executed by just inserting a screw in the fixation hole 26 and, thereafter, tightening the screw in the pillar 12.

In general, the fixation of the heating element 22 may be realized by merely using the fastening element according to FIGS. 1 to 4. Alternatively, just using the fixing solution with screws each penetrating a dedicated fixation hole 26 is possible as well. Naturally, a third option could be to combine the aforedescribed fixation solutions with both snap-in mechanism and screw in one and the same cooking hob.

FIG. 7 illustrates a schematic top view of the heating element 22 with fastening elements 10 according to the prior art. The heating element 22 may be an induction coil 22 or a radiant heating element. The heating element 22 comprises three fastening elements 10. Said fastening elements 10 are arranged at predefined positions at the heating element 22. The positions of the fastening elements 10 at the heating element 22 cannot be varied. The heating element 22 with the fastening elements 10 cannot be adapted to special geometric conditions of the cooking hob.

In contrast, the fastening system according to the present invention allows the flexible the arrangement of the three or more fastening elements 10 at the heating element 22. The same heating element 22 can be adapted to different geometric conditions of the cooking hob.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims. In particular, the inverse solution, i. e. at least one hook or pin arranged at the heating element, in particular at the border of a heating element, and a dedicated fixation hole at the fastening element shall be covered as an equivalent solution.

### LIST OF REFERENCE NUMERALS

10 fastening element
12 pillar
14 fixed hook element
16 moveable hook element
18 flexible supporting arm
20 socket
22 heating element, induction coil
24 border
26 fixation hole
30 plug
32 power cable
34 sensor cable
36 poka yoke element, recess
38 poka yoke element, slot

1. A fastening system for a heating element of a cooking hob, comprising at least three fastening elements each comprising a main body connectable or connected to a bottom and/or a side wall of the cooking hob.

2. The fastening system according to claim 1, wherein at least one of said fastening elements comprises a moveable hook element and a fixed hook element which are contacting each other or are connected to each other or are marginally spaced from each other in an assembled state of the heating element.

3. The fastening system according to claim 1, wherein at least one of said fastening elements includes a snap-in mechanism connectable or connected to a fixation hole of the heating element, wherein the snap-in mechanism includes a fixed hook element arranged directly on the main body and/or a moveable hook element connected to the main body via a flexible supporting arm.

4. The fastening system according to claim 3, wherein the fixed hook element is arranged directly on a top side of the main body, wherein the moveable hook element is connected to the top side of the main body via the flexible supporting arm.

5. The fastening system according to claim 1, wherein each said fastening element is formed as a single-piece part and/or is made of plastics.

6. The fastening system according to claim 1, wherein at least one of said fastening element comprises a hook element and/or a screw, the hook element and/or screw being moveable into or towards the main body of the fastening element, the main body of the fastening element being formed as a pillar.

7. The fastening system according to claim 6, wherein the moveable hook element and/or the screw is or are supported by a supporting arm which is connected to or arranged at the main body.

8. The fastening system according to claim 1, further comprising a heating element at least partially enclosed by a border with a plurality of fixing holes, wherein each said fixing hole is penetrated or penetrable by a screw and/or engageable or engaged with a snap-in mechanism of one of the fastening element, and wherein a fixed hook element and/or a moveable hook element of each said fastening element penetrates the associated fixing hole, when said fixing hole is engaged with the snap-in mechanism of the fastening element.

9. The fastening system according to claim 1, wherein at least one of said fastening elements includes at least one electric connector connectable or connected to a complementary electric connector of the heating element.

10. The fastening system according to claim 9, wherein at least one fastening element includes at least one socket connectable or connected to a plug of the heating element and/or connected or wired with a power and/or a signal cable(s) connected or connectable to an electric or electronic module or component of the cooking hob.

11. A heating element for a cooking hob, the heating element (22) being at least partially enclosed by a border with a plurality of fixing holes, wherein each said fixing hole is penetrated or penetrable by a screw and/or engageable or engaged with a snap-in mechanism of an associated one of said fastening elements of the fastening system according to claim 1.

12. The heating element according to claim 11, wherein each said fixing hole is penetrable by a fixed hook element and/or a moveable hook element of the associated fastening element when said fixing hole is engaged with the snap-in mechanism thereof, wherein the fixing holes are arranged along a circular path in the border of the heating element.

13. The heating element according to claim 11, wherein at least one of the fixing holes is formed as a poka yoke element, wherein said poka yoke element is a recess opened to an outer edge of the border and/or said poka yoke element is a slot or a key hole.

14. The heating element according to claim 11, wherein the heating element is an induction coil and includes at least one electric connector connectable or connected to a complementary electric connector of the fastening system, and at least one plug connectable or connected to at least one socket of the fastening system, and wherein said plug is connected to windings of the induction coil or a heating wire via power cables and/or to a sensor of the induction coil via sensor cables.

15. (canceled)

16. A fastener for fixing a heating element to a cooking hob, said fastener being formed as a single-piece part and comprising a pillar and a snap-in mechanism; said snap-in mechanism comprising a fixed hook element arranged directly on the pillar and a movable hook element arranged above the fixed hook element and attached to the pillar via a supporting arm; said movable hook element being movable from an unstressed stated where the fixed and movable hook elements are either contacting or marginally spaced from one another, to a stressed state where the movable hook element has been deflected thereby creating or widening a gap between said fixed and movable hook elements; said fixed and movable spring elements having respective, opposing inclined surfaces that together define a triangular insertion section adapted to accommodate insertion of a border of a heating element therebetween, such that said insertion of said border will deflect the movable spring element from said unstressed state in order to accommodate further insertion of said border of said heating element; said movable spring element being adapted to return to its unstressed state when forces urging deflection thereof have been removed; said pillar further comprising an upper surface adapted to accommodate and support a heating element thereon to support the same above a bottom surface of a cooking hob.

17. The fastener according to claim 16, further comprising a socket adapted to receive a plug of a heating element supported on the pillar thereof in order to provide electrical and sensor communication between an appliance comprising said hob and said heating element.

18. A cooking hob comprising: a heating element having a border comprising a plurality of fixing holes distributed in a circular pattern therein, and a plurality of the fasteners according to claim 16 distributed circumferentially about said border; each said fastener having said border inserted and received between said fixed and movable spring elements thereof in a direction radially outward of said heating element and perpendicular to a longitudinal axis of the pillar of the respective fastener, such that for each said fastener the movable spring element is in said unstressed state and at least one of said fixed and movable spring elements is received through the respective fixing hole of the border; said heating element resting on said upper surface of the pillar of said respective fastener.

19. The cooking hob according to claim 18, said border of said heating element being insertable between and removable from said fixed and movable spring elements without tools through reversible deflection of said movable element.

20. the cooking hob according to claim 18, said fixing holes being distributed about said border so that said plurality of fasteners can be affixed thereto at variable locations about said border, in order to attach said heating element to said cooking hob depending on installation conditions unique to the particular cooking hob.
